(19) United States
(12) Patent Application Publication
(10) Pub. No.: US 2008/0158918 A1
(43) Pub. Date: Jul. 3, 2008

(54) Switching regulator

(76) Inventor: Garan Hunter, Scappoose, OR (US)

Correspondence Address: CAVEN & AGHEVLI;c/o INTELLEVATE, LLC, P.O. BOX 52050, MINNEAPOLIS, MN, 55402, US

(21) Appl. No.: 11/648,854

(22) Filed: Dec. 29, 2006

(51) Int. Cl. H02M 1/00

(52) U.S. Cl. 363/49

(57) ABSTRACT

In some embodiments, a voltage regulator assembly comprises a linear regulator coupled to a first input voltage to generate an first output voltage, different from the first voltage, a switching regulator, and a bypass switch coupled to an input of the switching regular and switchable between a first position in which the first output from the linear regulator is applied as a bias input to the switching regulator and a second position in which the output of the switching regulator is applied as a bias input to the switching regulator. Other embodiments may be described.

### BACKGROUND

The subject matter described herein relates generally to the field of electronic devices and more particularly to switching regulators.

Power supplies generate power and maintain a relatively constant voltage and current for circuits of an electronic system. Power supplies generally convert an alternating current (AC) input voltage into a regulated direct current (DC) output voltage. In instances where the power supply input voltage is a DC voltage, the power supply may be a DC-DC converter such as a linear or a switching voltage regulator.

Multi-output switching regulator controllers can contain linear regulators for low current requirements. These parts may also have the capability to bypass the linear regulator when another switching regulator with the same output voltage is within its proper regulation voltage.

### BRIEF DESCRIPTION OF THE DRAWINGS

The detailed description is described with reference to the accompanying figures.

FIG. 1 is a schematic illustration of a voltage regulator assembly in accordance with some embodiments.

FIG. 2 is a flowchart illustrating aspects of the operation of the voltage regulator assembly depicted in FIG. 1, in accordance with some embodiments.

FIG. 3 is a schematic illustration of a timing diagram of aspects of the voltage regulator assembly depicted in FIG. 1.

FIG. 4 is a schematic illustration of an architecture of a computer system in accordance with some embodiments.

### DETAILED DESCRIPTION

Described herein are exemplary systems and methods for switching regulators which may be used in, e.g., computing devices. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

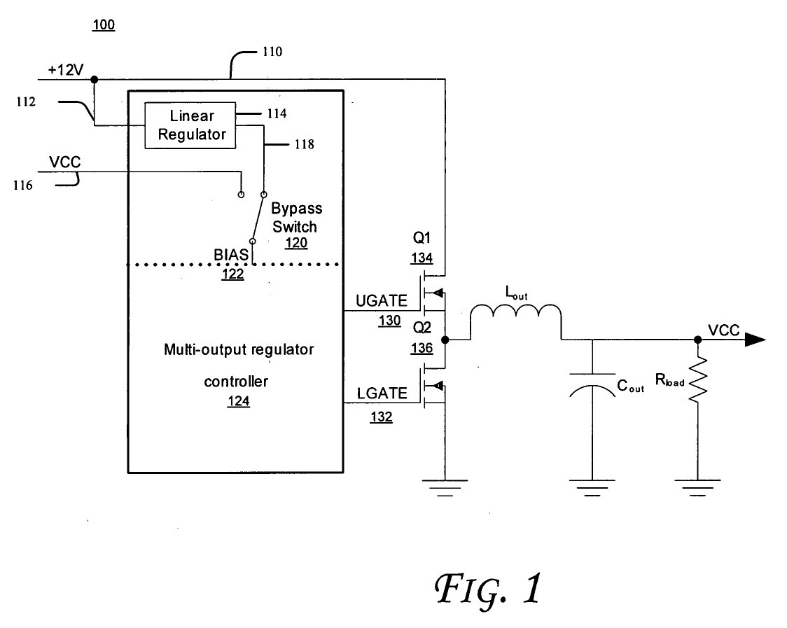

FIG. 1 is a schematic illustration of a voltage regulator assembly 100 in accordance with some embodiments. Referring to FIG. 1, a power supply voltage at a first voltage (e.g., 12V) is coupled to a power bus 110. A linear regulator 114 is coupled to the first input voltage via a bus 112. Linear regulator produces an output voltage on bus 118. In some embodiments, linear regular produces an output voltage of 5V in response to the input voltage of 12V.

Voltage regulator assembly 100 further includes a multi-output regulator controller, which may be embodied as a switching regulator 124. Switching regulator 124 includes a bias voltage input 122 and output gates 130, 132 coupled to transistors 134, 136.

Voltage regulator assembly 100 further includes a bypass switch 120. In some embodiments, bypass switch 120 is coupled to the bias input 122 of the switching regular 124 and may be switched between a first position in which the output 118 from the linear regulator 114 is applied as a bias input 122 to the switching regulator 124 and a second position in which the output 116 of the switching regulator is applied as a bias input 122 to the switching regulator 124.

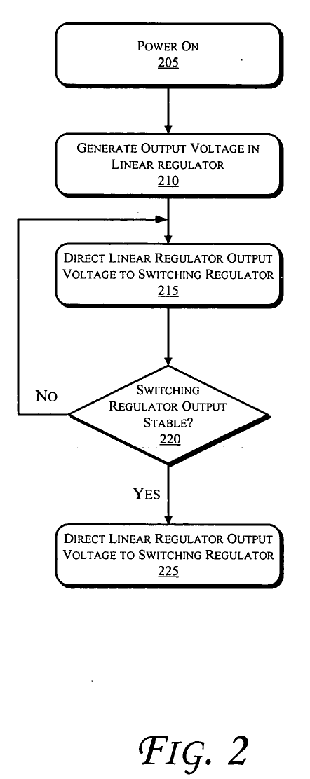

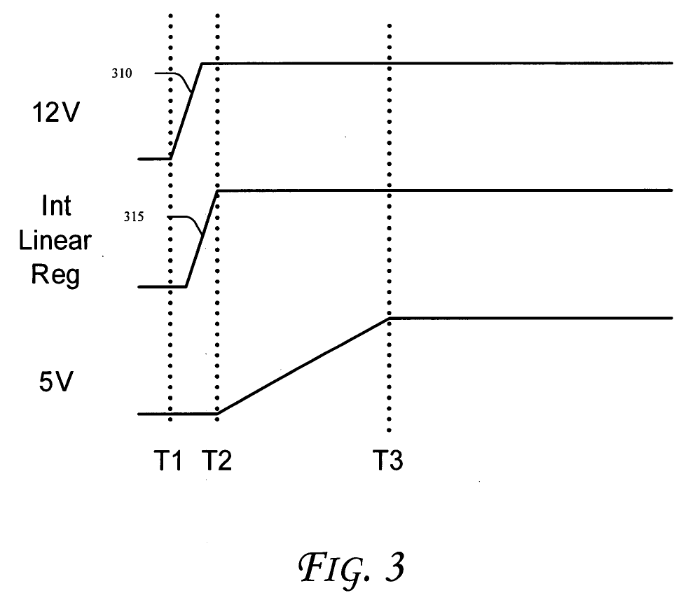

Operation of voltage regulator assembly 100 will be explained with referenced to FIG. 2 and FIG. 3. FIG. 2 is a flowchart illustrating aspects of the operation of the voltage regulator assembly depicted in FIG. 1, in accordance with some embodiments. FIG. 3 is a schematic illustration of a timing diagram of aspects of the voltage regulator assembly depicted in FIG. 1.

Referring to FIGS. 2 and 3, at operation 205 the voltage regulator assembly 100 is powered on, e.g., by applying an input voltage on bus 110 at time T1, whereupon the input voltage to linear regulator 114 begins to ramp (310) to the input voltage. At operation 210 linear regulator 114 generates an output voltage in response to the input voltage. Thus, the output voltage of linear regulator 114 ramps to an output voltage (315).

At operation 215 the output voltage of linear regulator 114 is directed to the bias input 122 of switching regulator 124. In some embodiments, the bypass switch may be coupled to the output bus 118 of linear regulator on power up of voltage regulator assembly 100 such that when the output voltage of linear regulator 114 reaches a steady state (i.e., at time T2) the output is applied to the bias input 122 of switching regulator 124.

If, at operation 220, the output of switching regulator 124 has not reached a stable state (i.e., before time T3 in FIG. 3), then bypass switch 120 remains coupled to bus 118 such that the output of linear regulator 114 is directed the bias input 122 of switching regulator 124. By contrast, if at operation 220 the output of switching regulator 124 has reached a stable state (i.e., after time T3 in FIG. 3), then at operation 225 bypass switch 120 is coupled to bus 116 such that the output of switching regulator 124 (i.e., VCC) is directed the bias input 122 of switching regulator 124.

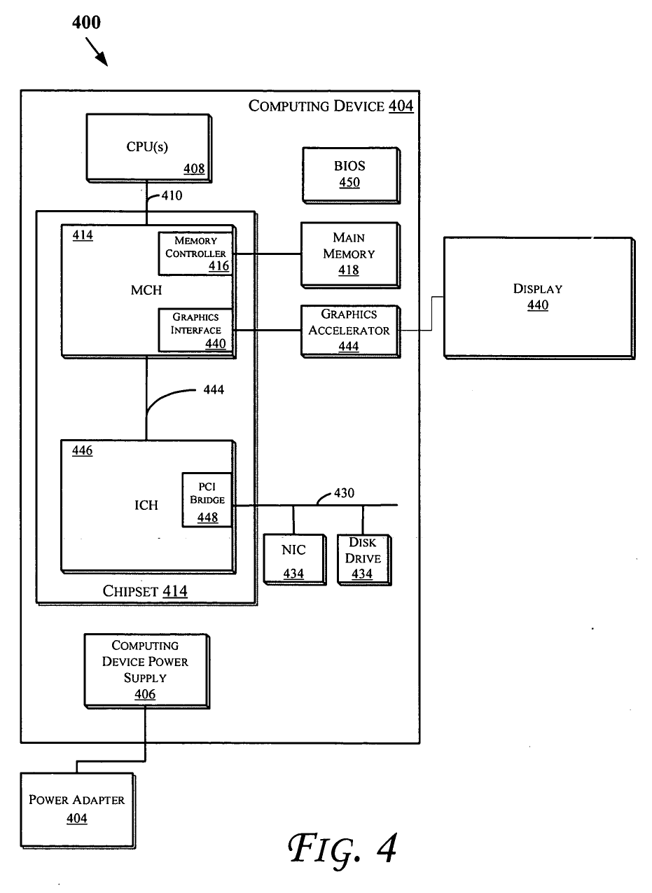

FIG. 4 is a schematic illustration of an architecture of a computer system adapted to implement semiconductor based host protected addressing in accordance with some embodiments. Computer system 400 includes a computing device 402 and a power adapter 404 (e.g., to supply electrical power to the computing device 402). The computing device 402 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 402 (e.g., through a computing device power supply 406) from one or more of the following sources: one or more battery packs, an alternating current (AC) outlet (e.g., through a transformer and/or adaptor such as a power adapter 404), automotive power supplies, airplane power supplies, and the like. In one embodiment, the power adapter 404 may transform the power supply source output (e.g., the AC outlet voltage of about 110 VAC to 240 VAC) to a direct current (DC) voltage ranging between about 7V DC to 12.6 VDC. Accordingly, the power adapter 404 may be an AC/DC adapter.

The computing device 402 may also include one or more central processing unit(s) (CPUs) 408 coupled to a bus 410. In one embodiment, the CPU 408 may be one or more processors in the Pentium® family of processors including the Pentium® II processor family, Pentium® III processors, Pentium® IV processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multi core design.

A chipset 412 may be coupled to the bus 410. The chipset 412 may include a memory control hub (MCH) 414. The MCH 414 may include a memory controller 416 that is coupled to a main system memory 418. The main system memory 418 stores data and sequences of instructions that are executed by the CPU 408, or any other device included in the system 400. In some embodiments, the main system memory 418 includes random access memory (RAM); however, the main system memory 418 may be implemented using other memory types such as dynamic RAM (DRAM), synchronous DRAM (SDRAM), and the like. Additional devices may also be coupled to the bus 410, such as multiple CPUs and/or multiple system memories.

In some embodiments, main memory 418 may include a one or more flash memory devices. For example, main memory 418 may include either NAND or NOR flash memory devices, which may provide hundreds of megabytes, or even many gigabytes of storage capacity.

The MCH 414 may also include a graphics interface 420 coupled to a graphics accelerator 422. In one embodiment, the graphics interface 420 is coupled to the graphics accelerator 422 via an accelerated graphics port (AGP). In an embodiment, a display (such as a flat panel display) 440 may be coupled to the graphics interface 420 through, for example, a signal converter that translates a digital representation of an image stored in a storage device such as video memory or system memory into display signals that are interpreted and displayed by the display. The display 440 signals produced by the display device may pass through various control devices before being interpreted by and subsequently displayed on the display.

A hub interface 424 couples the MCH 414 to an input/output control hub (ICH) 426. The ICH 426 provides an interface to input/output (I/O) devices coupled to the computer system 400. The ICH 426 may be coupled to a peripheral component interconnect (PCI) bus. Hence, the ICH 426 includes a PCI bridge 428 that provides an interface to a PCI bus 430. The PCI bridge 428 provides a data path between the CPU 408 and peripheral devices. Additionally, other types of I/O interconnect topologies may be utilized such as the PCI Express™ architecture, available through Intel® Corporation of Santa Clara, Calif.

The PCI bus 430 may be coupled to a network interface card (NIC) 432 and one or more disk drive(s) 434. Other devices may be coupled to the PCI bus 430. In addition, the CPU 408 and the MCH 414 may be combined to form a single chip. Furthermore, the graphics accelerator 422 may be included within the MCH 414 in other embodiments.

Additionally, other peripherals coupled to the ICH 426 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like.

System 400 may further include a basic input/output system (BIOS) 450 to manage, among other things, the boot-up operations of computing system 400. BIOS 450 may be embodied as logic instructions encoded on a memory module such as, e.g., a flash memory module.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A system, comprising:
a display
one or more integrated circuits;
a linear regulator coupled to a first input voltage to generate an first output voltage, different from the first voltage;
a switching regulator;
a bypass switch coupled to an input of the switching regular and switchable between a first position in which the first output from the linear regulator is applied as a bias input to the switching regulator and a second position in which the output of the switching regulator is applied as a bias input to the switching regulator.

2. The system of claim 1, wherein the linear regulator receives a 12V input voltage and generates a 5V output voltage.

3. The system of claim 1, wherein the switching regulator receives a bias input of 5V and generates an output of 5V.

4. The system of claim 1, wherein the bypass switch is switched from the first position to the second position after the switching regulator reaches a steady state output.

5. A voltage regulator assembly, comprising:
a linear regulator coupled to a first input voltage to generate an first output voltage, different from the first voltage;
a switching regulator;
a bypass switch coupled to an input of the switching regular and switchable between a first position in which the first output from the linear regulator is applied as a bias input to the switching regulator and a second position in which the output of the switching regulator is applied as a bias input to the switching regulator.

6. The voltage regulator assembly of claim 5, wherein the linear regulator receives a 12V input voltage and generates a 5V output voltage.

7. The voltage regulator assembly of claim 5, wherein the switching regulator receives a bias input of 5V and generates an output of 5V.

8. The voltage regulator assembly of claim 5, wherein the bypass switch is switched from the first position to the second position after the switching regulator reaches a steady state output.

9. A method, comprising:
generating, in a linear regulator, a first output voltage based on a first input voltage;
applying the first output voltage from the linear regulator as a bias voltage to a switching regulator;
activating the switching regulator; and
switching the bias voltage after the switching regulator reaches a steady state output.

10. The method of claim 9, wherein generating, in a linear regulator, a first output voltage based on a first input voltage comprises generating a 5V output voltage based on a 12V input voltage.

11. The method of claim 9, wherein applying the first output voltage from the linear regulator as a bias voltage to a switching regulator comprises switching the first output voltage from the linear regulator to a bias voltage input of a switching regulator.

12. The method of claim 9, wherein switching the bias voltage after the switching regulator reaches a steady state output comprises switching a bias voltage input of a switching regulator from the first output voltage of the linear regulator to an output voltage of the switching regulator.
